(19) United States
(12) Patent Application Publication
(10) Pub. No.: US 2004/0081425 A1
(43) Pub. Date: Apr. 29, 2004

(54) Method and apparatus for accessing medium interactive feature data and controlling a medium player

(75) Inventors: Christopher J. Stone, Newtown, PA (US); Joseph F. Halgas JR., Huntingdon Valley, PA (US); John P. Kamieniecki, Lafayette Hill, PA (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: General Instrument Corporation

(21) Appl. No.: 10/279,259

(22) Filed: Oct. 23, 2002

(51) Int. Cl. H04N 5/781

(52) U.S. Cl. 386/46; 386/125

(57) ABSTRACT

Interactive feature data is accessed with an auxiliary display device that controls a medium player (e.g., DVD player). The interactive feature data is stored on an insertably-removable data storage medium which is inserted in the medium player. The data storage medium also has video data stored thereon which is viewed on a screen device when the data storage medium is played by the medium player. In one embodiment, the interactive feature data is copied from the data storage medium to at least one memory location external to the data storage medium and is viewed on the auxiliary display device while only the video data is viewed on the screen device. In another embodiment, the medium player is controlled by accessing a website on the Internet which instructs the auxiliary display device to send commands to the medium player when command links presented on a webpage of the website are selected.

### BACKGROUND OF THE INVENTION

1. Field of the Invention

The present invention generally relates to the use and control of a medium player and the data on a medium that the medium player plays.

2. Background Information

The development of digital versatile disks (DVDs) began in 1991 when Pioneer Corporation established a goal to record two or more hours of high-quality video on one disc, as a next-generation replacement for the LaserDisc. Along with an original motion picture, many DVDs are encoded with a plurality of interactive features, such as deleted scenes, interviews with actors and/or the director, a documentary on the making of the motion picture, or the like. Other interactive features allow a viewer to design and navigate a custom graphical user interface.

In order to fully enjoy and appreciate the interactive content on a DVD, a user is currently required to insert the DVD into a DVD player and view the content of the DVD on a screen (e.g., television). The user is presently unable to view the interactive content while at the same time playing a movie residing on the same DVD. Furthermore, current standalone DVD players are unable to access the Internet.

It would be desirable to be able to access the interactive features on a DVD, including those features requiring Internet access, without interrupting the playback of a program (e.g., movie) on the DVD. Preferably, it would be desired to access the interactive features on the DVD at another location independent of the DVD. Such a feature would allow the user to enjoy a greatly-enhanced interactive video experience.

### SUMMARY OF THE INVENTION

The present invention is a method of accessing interactive feature data with an auxiliary display device that controls a medium player. The interactive feature data is stored on an insertably-removable data storage medium which is inserted in the medium player. The medium player is in communication with a screen device. The data storage medium also has video data stored thereon which is viewed on the screen device when the data storage medium is played by the medium player. The interactive feature data is copied from the data storage medium to at least one memory location external to the data storage medium. The interactive feature data is viewed on the auxiliary display device while only the video data is viewed on the screen device. The viewed interactive feature data is accessed from the external memory location.

The auxiliary display device may receive an information signal including an identifier indicating the external memory location. The auxiliary display device may use the identifier to view the interactive feature data. The identifier may be a uniform resource locator (URL) associated with the memory location. The medium player may not have access to the Internet. The auxiliary display device may display a predetermined Internet website having a webpage with command links embedded therein, select one of the command links, receive from the website a first control signal associated with the selected command link, and in response to receiving the first control signal, send a second control signal to the medium player to perform a function associated with the selected command link.

The interactive feature data may be copied to the external memory location only if the interactive feature data does not already reside in the external memory location. The auxiliary display device may access the interactive feature data via the Internet. The interactive feature data may include at least one uniform resource locator (URL) of a website associated with the video data. The interactive feature data may be used by the auxiliary display device to control the medium player. The medium player may be located in a cable television set-top box.

The medium may be a digital versatile disc (DVD), a compact disc (CD) or an optical disc. The medium player may be located in a cable television set-top box

In an alternate embodiment, the present invention is a method of controlling a medium player with an auxiliary display device. The medium player has inserted therein an insertably-removable data storage medium. The auxiliary display device displays a predetermined Internet website having a webpage with command links embedded therein and one of the command links is selected. A first control signal associated with the selected command link is received from the website. In response to receiving the first control signal, a second control signal is sent to the medium player to perform a function associated with the selected command link.

The medium player may be in communication with a screen device, and the data storage medium may have interactive feature data and video data stored thereon which is viewed on the screen device when the data storage medium is played by the medium player. The interactive feature data may be copied from the data storage medium to at least one memory location external to the data storage medium. The interactive feature data may be viewed on the auxiliary display device while only the video data is viewed on the screen device. The viewed interactive feature data may be accessed from the external memory location. The auxiliary display device may receive an information signal including an identifier indicating the external memory location. The auxiliary display device may use the identifier to view the interactive feature data.

The second control signal may instruct the medium player to play data at a specific location on the data storage medium. The second control signal may indicate a specific track number. The medium player may be in communication with a screen device that has a menu displayed thereon, and the second control signal may instruct the medium player to change the location of a cursor used to make selections from the menu. The screen device may be a television. The first control signal may include a uniform resource identifier (URI). The second control signal may be an infrared (IR) signal.

The second control signal may instruct the medium player to play the data storage medium or stop playing the data storage medium. The second control signal may instruct the medium player to change the volume of audio outputted by the medium player when playing the data storage medium. The second control signal may instruct the medium player to turn the medium player on or off. The medium player may be located in a cable television set-top box.

In another embodiment of the present invention, a medium player is used to process interactive feature data stored on a plurality insertably-removable data storage mediums which are inserted in the medium player one at a time and played. The medium player is in communication with a screen device. Each of the data storage mediums also have video data stored thereon which is viewed on the screen device when the data storage medium is played by the medium player. The medium player includes means for selectively extracting only the interactive feature data from each of the storage mediums, and a plurality of memory locations external to the storage mediums. The memory locations are used to store only the interactive feature data from each of the data storage mediums. The memory location associated with the storage medium that is currently being played by the medium player is remotely accessed by an auxiliary display device without interrupting the viewing of the video data on the screen device.

The medium player may also include means for sending an information signal to the auxiliary display device. The information signal may include an identifier indicating the memory location that is associated with the storage medium that is currently being played by the medium player. The identifier may be a uniform resource locator (URL).

In yet another embodiment of the present invention, a medium player includes means for selectively extracting only the interactive feature data from each of the storage mediums, processing the interactive feature data and sending the processed interactive feature data to the respective external memory locations for storage. Furthermore, the medium player includes means for sending an information signal to an auxiliary display device that remotely accesses the memory location associated with the storage medium that is currently being played by the medium player without interrupting the viewing of the video data on the screen device.

### BRIEF DESCRIPTION OF THE DRAWINGS

The following detailed description of preferred embodiments of the present invention would be better understood when read in conjunction with the appended drawings. For the purpose of illustrating the present invention, there are shown in the drawings embodiments which are presently preferred. However, the present invention is not limited to the precise arrangements and instrumentalities shown. In the drawings:

FIG. 1 is a block diagram of a consumer-electronics product integrated with a DVD player in accordance with the present invention;

FIG. 2 is a block diagram of a cable television system that incorporates the consumer-electronics product of FIG. 1;

FIG. 3 is a flow chart including method steps of accessing interactive feature data with an auxiliary display device in accordance with one embodiment of the present invention; and

FIG. 4 is a flow chart including method steps of controlling a medium player with an auxiliary display device in accordance with another embodiment of the present invention.

### DETAILED DESCRIPTION OF THE INVENTION

The present invention allows a user to enjoy interactive enhancements while viewing a video program as it is played by a medium player and displayed on a screen (e.g., TV). The medium may be a digital versatile disc (DVD), compact disc (CD), optical disc or the like. The medium player may be located in a consumer-electronics product, such as a cable set-top box (STB).

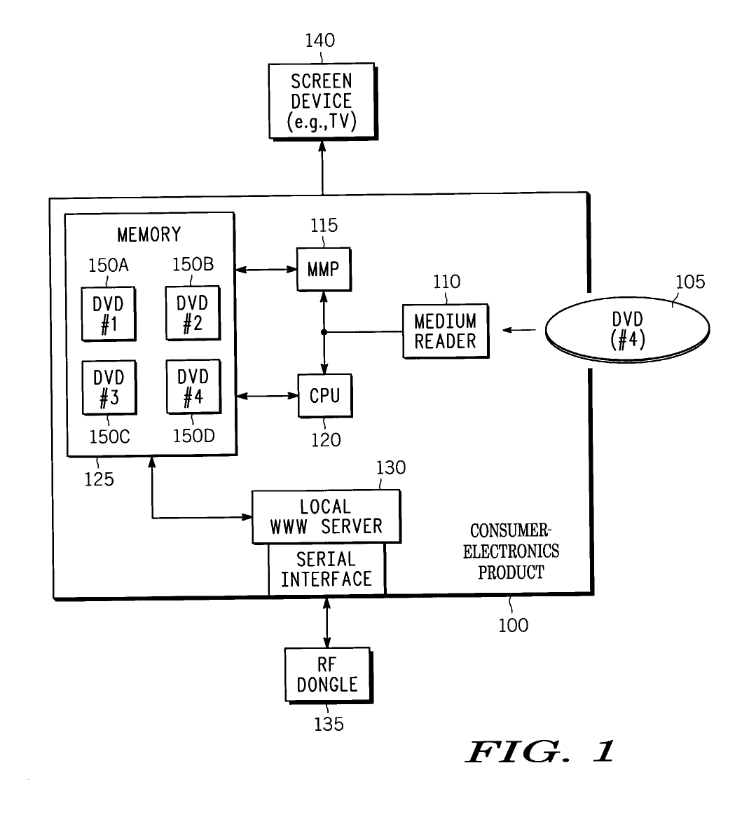

FIG. 1 is a block diagram of a consumer-electronics product 100 that combines an interactive digital cable terminal (i.e., set-top box) with popular home-theater system entertainment technologies, such as a DVD player, CD audio player, or audio/video receiver. The consumer-electronics product 100 has inserted within a DVD 105 from which interactive data is read by a medium reader 110 and processed by a multimedia processor (MMP) 115 in conjunction with a computer processing unit (CPU) 120. The extracted interactive data is then stored in a memory 125. A local World Wide Web (WWW) server 130 provides a gateway via RF dongle 135 to broadband services such as video-on-demand movies, local source information, electronic programming guides and pay-per-view movies and events. The video data stored on DVD 105 is viewed on screen device (e.g., television) 140.

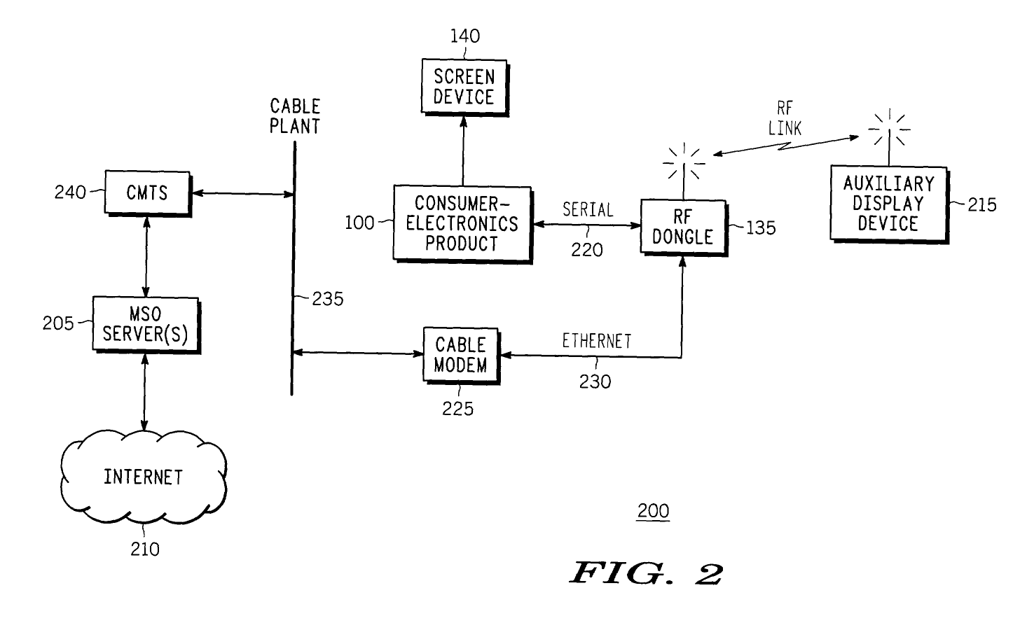

Thus, the consumer-electronics product 100 serves as a medium player for processing interactive feature data stored on a plurality insertably-removable data storage mediums (e.g., DVDs) 105. The data storage mediums are inserted in the medium player one at a time and played. As an example, DVD 105 is labeled as “#4” which is intended to imply that three other DVDs were inserted in the consumer-electronics product 100 and played prior to DVD 105. Each of the DVDs also has video data stored thereon which is viewed on the screen device when the data storage medium is played by the consumer-electronics product 100. The consumer-electronics product 100 includes MMP 115 and CPU 120 for selectively extracting only the interactive feature data from each of the storage mediums. The consumer-electronics product 100 also includes a plurality of memory locations 150A, 150B, 150C, 150D in memory 125 which are external to the DVDs inserted in the consumer-electronics product 100. The memory locations 150A, 150B, 150C, 150D are used to store only the interactive feature data from each of the four data storage mediums (three of which were previously inserted and played). The memory location 150D associated with the DVD 105 that is currently being played by the consumer-electronics product 100 is remotely accessed by an auxiliary display device 215 (see FIG. 2) via RF dongle 135 without interrupting the viewing of the video data on the screen device 140.

The World Wide Web (WWW) server 130 sends an information signal to the auxiliary display device 215. The information signal includes an identifier indicating the memory location that is associated with the storage medium and which is currently being played by the medium player. The identifier may be a uniform resource locator (URL).

FIG. 2 shows one embodiment of the present invention in a cable television environment 200. Once a DVD is inserted in the consumer-electronics product 100, the consumer-electronics product 100 reads the “digital fingerprint” of the DVD. The consumer-electronics product 100 then polls the MSO server 205, or some other server that may reside on the Internet 210, to determine if the MSO server 205 already contains the interactive data on the DVD. If the MSO server 205 does not already contains the interactive data, then the MSO server 205 creates an applicable directory structure and reformats the interactive data accordingly. The MSO server 205 then forwards a URL associated with the MSO server to the consumer-electronics product 100 which passes the URL to an auxiliary display device 215 via the RF dongle 135. The auxiliary display device 215 communicates with a serial interface of the consumer-electronics product 100 via RF dongle 135 and serial connection 220. The RF dongle 135 is an access point using the 802.11 protocol (e.g., Connection Point in the HomeRF® protocol) which is also connected to a cable modem 225 via an Ethernet/USB cable 230. The cable modem 225 is connected to cable plant 235. A cable modem terminating system is connected between the cable plant 235 and MSO server 205, which in turn is connected to the Internet 210.

In conjunction with the consumer-electronics product 100, the auxiliary display device 215 controls the consumer-electronics product 100 by sending control signals to RF dongle 135. If the user of the auxiliary display device 215 desires to interface with the interactive data residing on the DVD 105, a URL associated with the memory location in which the interactive data has been stored is used to initiate a hypertext transfer protocol (HTTP) session. The memory location may be within the consumer-electronics product 100 and/or in MSO server 205.

In one embodiment, the auxiliary display device 215 is a wireless, touch-screen, hand-held device that helps enhance the television viewing experience. The auxiliary display device 215 is capable of communicating with the Internet 210 to access information associated with the video program being played on the consumer-electronics product 100, without disturbing the viewing of the video program.

The present invention allows the user to enjoy all of the interactive features of a DVD or other medium playing in the consumer-electronics product 100 without needing to pause or stop the playback of the DVD. Using the auxiliary display device 215, the present invention allows the user to navigate the DVD interactive menu features and also control the consumer-electronics product 100. The auxiliary display device may be used to “surf” websites based on uniform resource locators (URLs) supplied by the DVD while the video program on the DVD is played by the consumer-electronics product 100 undisturbed.

The consumer-electronics product 100 extracts the interactive feature data from the DVD 105 and stores it in a memory location external to the DVD 105. The external memory location may reside in the consumer-electronics product 100 whereby the extracted interactive data may be accessed via an internal server 130 via a serial port on the consumer-electronics product 100. The consumer-electronics product 100 then parses the data and converts any viewable data into a format that is compatible with the auxiliary display device (e.g., digital video (DV) movie clips are converted to audio video interleave (AVI), etc.). The consumer-electronics product 100 may also pass the extracted interactive data to an external device, such as a locally connected personal computer (PC) or a server 205 residing in the head-end of a multiple service operator (MSO). The consumer-electronics product 100 may poll the MSO server 205 to determine if the MSO server already contains the extracted interactive data, which may have been extracted and stored by a previous session from another user. If the extracted interactive data already resides in the MSO server 205, the consumer-electronics product 100 does not pass the same data to the MSO server 205 again. After the extraction process, the consumer-electronics product 100 sends an information signal indicating that the extracted interactive data was available. The information signal includes an identifier (e.g., URL) indicating the location of the external memory to the auxiliary display device. The auxiliary display device may access the extracted interactive data in the MSO server 205 via a wireless local area network (WLAN) and RF bridge connected between the serial port of the consumer-electronics product 100 and the Internet 210. The extracted interactive data may be in HTML format. If the interactive data is not in HTML format, it is then converted accordingly.

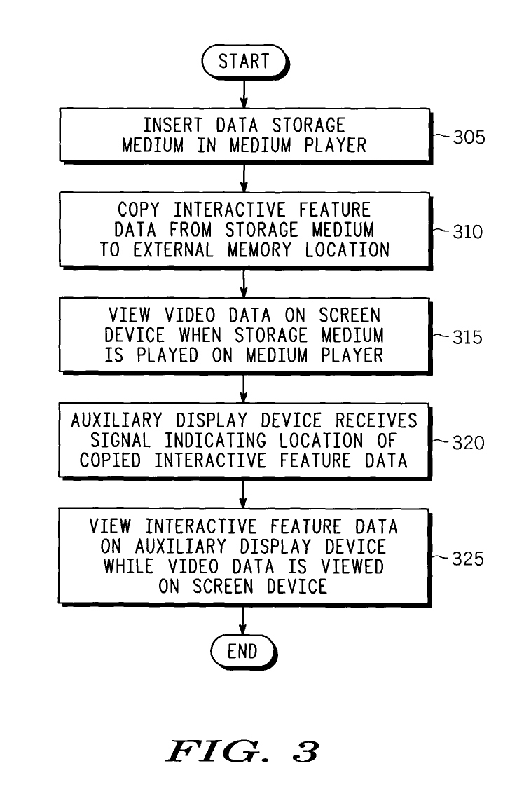

FIG. 3 shows the method steps of accessing interactive feature data with an auxiliary display device that controls a medium player in accordance with the present invention. In step 305, an insertably-removable data storage medium is inserted in a medium player. The data storage medium includes interactive feature data and video data (e.g., movie) stored thereon. In step 310, the interactive feature data (i.e., data that serves as a supplement to the video data) is copied from the data storage medium to at least one memory location external to the data storage medium. In step 315, the video data is viewed when the inserted storage medium is played on the medium player. In step 320, the auxiliary display device receives a signal indicating the location of the copied interactive feature data. In step 325, the interactive feature data is viewed on the auxiliary display device while only the video data is viewed on the screen device. The viewed interactive feature data is accessed from the external memory location.

In another embodiment of the present invention, a method and system is provided such that medium authors (content providers) are able to create an insertably-removable data storage medium (e.g., DVD, CD), while at the same time designing and implementing a website to co-exist with the medium. The authors may package the medium and provide URL information within that packaging. The URL may be applied as a label to the package or be presented on an on-screen display (e.g., television). When the user places an insertably-removable data storage medium into a medium player, the user may interact with the medium via the use of an auxiliary display device that has access to the Internet and controls the medium player.

The medium author establishes a website that contains generic commands for interacting with a designated medium. The auxiliary display device is designed to understand these commands and has the ability to process the commands accordingly. The commands may be similar to those currently associated with a medium player: PLAY, PAUSE, STOP, FAST FORWARD, TRACK SELECT, MENU, or the like. The generic commands are embedded in a web page at the website in the form of command links. The user may interact with the medium inserted in the medium player by visiting the specified website and depressing/clicking on a particular command link which causes the website to send a control signal associated with the particular command link to the auxiliary display device. Upon receipt of the control signal, the auxiliary display device sends a second control signal to the medium player. The second control signal may be in the form of an infrared (IR) blast code associated with the user's particular type of medium player.

To relay the generic command information and appropriate action that the auxiliary display device must take, a modification to the HTML protocol is required. A generic command may be in the form of the uniform resource identifier (URI) “IRcommand:” which enables the content provider with the ability to assign various generic medium commands to an associated link. The syntax of the “IRcommand:” URI is IRcommand:<command[1]; . . . command[n];end> which specifies a string of commands terminated by the “end” identifier. The string of commands is included in the second command signal transmitted by the auxiliary display device to the medium player. For example, activating IRcommand:Play;2;9;end causes the auxiliary display device to issue corresponding commands (e.g., IR codes) to the medium player instructing it to play track number 29 of the medium inserted therein.

The “IRcommand:” URI is associated with a HTML anchor tag (<A>) of a link such that when the link is selected a generic command is activated. For example, the text “Check out the Lobby Scene!!!” is an HTML link in the following generic command: <a href=“IRcommand:Play;2;9;end”>Check out the Lobby Scene!!!</a>. The HTML link causes a first control signal to be sent to the auxiliary display device instructing it to send a second control signal to the medium player. The second control signal instructs the medium player to play track number 29.

The auxiliary display device allows a user to setup and configure a particular medium player. For example, a user may select a Sony DVPXXX DVD player from a menu list presented on the website. Each item on the list is associated with a set of commands for a particular medium player. Once selected, the specific set of commands may be stored in memory in the auxiliary display device for future use.

A list of applicable generic commands with their descriptions in parentheses follows and may be modified as desired:

“1” (The number 1 key/button)

“2” (The number 2 key/button)

“3” (The number 3 key/button)

“4” (The number 4 key/button)

“5” (The number 5 key/button)

“6” (The number 6 key/button)

“7” (The number 7 key/button)

“8” (The number 8 key/button)

“9” (The number 9 key/button)

“0” (The number 0 key/button)

“Vol_up” (Turn the volume up)

“Vol_dn” (Turn the volume down)

“Mute” (Mute the volume)

“Skip_up” (Skip to the next track on the medium)

“Skip_dn” (Skip to the previous track on the medium)

“Power” (Turn the medium player on or off)

“Repeat” (Repeat the current track/title)

“Play” (Play the medium)

“Stop” (Stop playing the medium)

“Ffwd” (Fast forward the medium)

“Reverse” (Reverse the medium)

“Pause” (Pause playing the medium)

“Menu” (Activate an on-screen menu associated with the medium)

“Up” (Move the on-screen cursor up)

“Down” (Move the on-screen cursor down)

“Left” (Move the on-screen cursor left)

“Right” (Move the on-screen cursor right)

“Select” (Select a highlighted item on the menu)

“Exit” (Exit the on-screen menu)

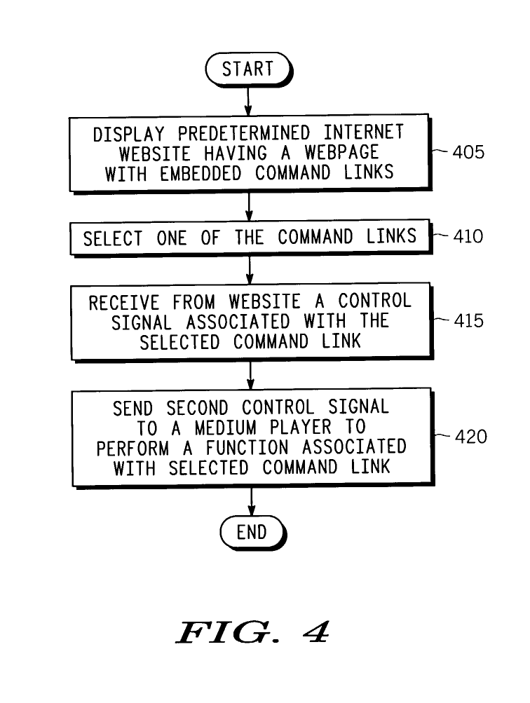

FIG. 4 shows the method steps of controlling a medium player with an auxiliary display device in accordance with the present invention. The medium player has inserted therein an insertably-removable data storage medium. In step 405, the auxiliary display device displays a predetermined Internet website having a webpage with command links embedded therein. In step 410, one of the command links is selected. In step 415, a first control signal associated with the selected command link is received from the website. In step 420, in response to receiving the first control signal, a second control signal is sent to the medium player to perform a function associated with the selected command link.

The present invention may be implemented with any combination of hardware and software. If implemented as a computer-implemented apparatus, the present invention is implemented using means for performing all of the steps and functions described above.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A method of accessing interactive feature data with an auxiliary display device that controls a medium player, the interactive feature data being stored on an insertably-removable data storage medium which is inserted in the medium player, the medium player being in communication with a screen device, the data storage medium also having video data stored thereon which is viewed on the screen device when the data storage medium is played by the medium player, the method comprising:
(a) copying the interactive feature data from the data storage medium to at least one memory location external to the data storage medium; and
(b) viewing the interactive feature data on the auxiliary display device while only the video data is viewed on the screen device, the viewed interactive feature data being accessed from the external memory location.

2. The method of claim 1 further comprising:
(c) the auxiliary display device receiving an information signal including an identifier indicating the external memory location; and
(d) the auxiliary display device using the identifier to view the interactive feature data.

3. The method of claim 2 wherein the identifier is a uniform resource locator (URL) associated with the memory location.

4. The method of claim 1 wherein the medium player does not have access to the Internet, the method further comprising the auxiliary display device:
(c) displaying a predetermined Internet website having a webpage with command links embedded therein;
(d) selecting one of the command links;
(e) receiving from the website a first control signal associated with the selected command link; and
(f) in response to receiving the first control signal, sending a second control signal to the medium player to perform a function associated with the selected command link.

5. The method of claim 1 wherein the interactive feature data is copied to the external memory location only if the interactive feature data does not already reside in the external memory location.

6. The method of claim 1 wherein step (b) further comprises the auxiliary display device accessing the interactive feature data via the Internet.

7. The method of claim 1 wherein the interactive feature data includes at least one uniform resource locator (URL) of a website associated with the video data.

8. The method of claim 1 wherein the interactive feature data is used by the auxiliary display device to control the medium player.

9. The method of claim 1 wherein the medium is a digital versatile disc (DVD).

10. The method of claim 1 wherein the medium is a compact disc (CD).

11. The method of claim 1 wherein the medium is an optical disc.

12. The method of claim 1 wherein the medium player is located in a cable television set-top box.

13. A method of controlling a medium player with an auxiliary display device, the medium player having inserted therein an insertably-removable data storage medium, the method comprising the auxiliary display device:
(a) displaying a predetermined Internet website having a webpage with command links embedded therein;
(b) selecting one of the command links;
(c) receiving from the website a first control signal associated with the selected command link; and
(d) in response to receiving the first control signal, sending a second control signal to the medium player to perform a function associated with the selected command link.

14. The method of claim 13 wherein the medium player is in communication with a screen device, and the data storage medium has interactive feature data and video data stored thereon which is viewed on the screen device when the data storage medium is played by the medium player, the method further comprising:
(e) copying the interactive feature data from the data storage medium to at least one memory location external to the data storage medium;
(f) viewing the interactive feature data on the auxiliary display device while only the video data is viewed on the screen device, the viewed interactive feature data being accessed from the external memory location.

15. The method of claim 14 further comprising:
(g) the auxiliary display device receiving an information signal including an identifier indicating the external memory location; and
(h) the auxiliary display device using the identifier to view the interactive feature data.

16. The method of claim 13 wherein the second control signal instructs the medium player to play data at a specific location on the data storage medium.

17. The method of claim 16 wherein the second control signal indicates a specific track number.

18. The method of claim 13 wherein the medium player is in communication with a screen device that has a menu displayed thereon, and the second control signal instructs the medium player to change the location of a cursor used to make selections from the menu.

19. The method of claim 18 wherein the screen device is a television.

20. The method of claim 13 wherein the first control signal includes a uniform resource identifier (URI).

21. The method of claim 13 wherein the second control signal is an infrared (IR) signal.

22. The method of claim 13 wherein the data storage medium is a digital versatile disc (DVD).

23. The method of claim 13 wherein the data storage medium is a compact disc (CD).

24. The method of claim 13 wherein the data storage medium is an optical disc.

25. The method of claim 13 wherein the second control signal instructs the medium player to play the data storage medium.

26. The method of claim 13 wherein the second control signal instructs the medium player to stop playing the data storage medium.

27. The method of claim 13 wherein the second control signal instructs the medium player to change the volume of audio outputted by the medium player when playing the data storage medium.

28. The method of claim 13 wherein the second control signal instructs the medium player to turn the medium player on or off.

29. The method of claim 13 wherein the medium player is located in a cable television set-top box.

30. A medium player for processing interactive feature data stored on a plurality insertably-removable data storage mediums which are inserted in the medium player one at a time and played, the medium player being in communication with a screen device, each of the data storage mediums also having video data stored thereon which is viewed on the screen device when the data storage medium is played by the medium player, the medium player comprising:
(a) means for selectively extracting only the interactive feature data from each of the storage mediums; and
(b) a plurality of memory locations external to the storage mediums, the memory locations being used to store only the interactive feature data from each of the data storage mediums, wherein the memory location associated with the storage medium that is currently being played by the medium player is remotely accessed by an auxiliary display device without interrupting the viewing of the video data on the screen device.

31. The medium player of claim 30 further comprising:
(c) means for sending an information signal to the auxiliary display device, the information signal including an identifier indicating the memory location that is associated with the storage medium that is currently being played by the medium player.

32. The medium player of claim 31 wherein the identifier is a uniform resource locator (URL).

33. A medium player for processing interactive feature data stored on a plurality insertably-removable data storage mediums which are inserted in the medium player one at a time and played, the medium player being in communication with a screen device and a plurality of memory locations external to the storage mediums, each of the data storage mediums also having video data stored thereon which is viewed on the screen device when the data storage medium is played by the medium player, the medium player comprising:
(a) means for selectively extracting only the interactive feature data from each of the storage mediums, processing the interactive feature data and sending the processed interactive feature data to the respective external memory locations for storage; and
(b) means for sending an information signal to an auxiliary display device that remotely accesses the memory location associated with the storage medium that is currently being played by the medium player without interrupting the viewing of the video data on the screen device.

34. The medium player of claim 33 wherein the information signal includes a uniform resource locator (URL).
